(19) United States
(12) Patent Application Publication
(10) Pub. No.: US 2005/0059410 A1
(43) Pub. Date: Mar. 17, 2005

(54) System and method for providing differential location services

(75) Inventors: Dirk Trossen, Cambridge, MA (US); Dana Pavel, Cambridge, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/664,316

(22) Filed: Sep. 17, 2003

(51) Int. Cl. H04Q 7/20

(52) U.S. Cl. 455/456.1; 455/414.2

(57) ABSTRACT

A system and method are presented for providing a differential location to a terminal. The system includes a service provider that can receive a request for a differential location service from the terminal at least partially over a wireless network, where the request includes a geographic area defined independent of a specific format. A mapping processor can receive the geographic area from the service provider, and thereafter transform the geographic area of the request to thereby define the geographic area in a predetermined manner. The mapping processor can send the geographic area defined in the predetermined manner to the service provider. Upon receiving the geographic area defined in the predetermined manner, the service provider can determine whether to provide the requested differential location service based upon a comparison of a current location of the terminal and the geographic area defined in the predetermined manner.

### FIELD OF THE INVENTION

The present invention relates generally to systems and methods for providing location information regarding a mobile station and, more particularly, relates to systems and methods for access control in the delivery of location information regarding a mobile station.

### BACKGROUND OF THE INVENTION

In many wireless communication networks and other mobile networks, the network keeps track of the location of mobile stations, such as mobile telephones, at least on a cell level. In such networks, it is typically also possible to determine the geographic location of the mobile stations, and provide services based upon the location of the mobile stations. For example, IN-based solutions have been implemented, triggering certain Intelligent Network (IN) functionality, such as call forwarding or call barring, based on the location information of a mobile station, and thus the mobile subscriber. Also in current systems implementing the Global System for Mobile Communications (GSM) standard, local Short Messaging Service (SMS) messages can be provided based on the current location of a subscribing mobile station.

In various applications, service announcements can be transmitted to mobile stations on the basis of a service request of a subscriber in mobile communication systems. Generally, these chargeable services are most often arranged to be provided from outside the actual mobile communication system. By making a call to a required service number or sending a request over the Internet, for example, a mobile subscriber is able to order a selected service announcement to be delivered to the display of the mobile station, for example. Of these individual services, e.g., weather forecast, traffic announcements, local news and other local services, such as taxi ordering and service station announcements and so on, are services where the mobile subscriber selects the desired announcement on the basis of the geographic area. The mobile subscriber generally wishes to have the service announcement related to his/her current location which varies because of the mobile nature of the mobile subscriber.

A special type of location-based service, often referred to as a differential location service, provides functionality based on the distance of the mobile station between two or more locations. For example, when the mobile station, and thus the mobile subscriber, moves to a location exceeding a predefined distance from the location of a desired meeting location, various precautionary actions can be triggered, such as sending out “running late” messages to the attendants of a meeting at the meeting location.

Whereas current techniques are adequate for providing location services, and differential location services, such techniques have drawbacks. In this regard, conventional techniques for providing location services are typically bound to specified operators or systems as such techniques rely on dedicated network functionality, such as IN signaling or cell ID information in GSM. And with the increasing importance of service provisioning in a multidimensional heterogeneity, network- and system-bound techniques for providing location services do not typically adequately provide location services across networks, operators, vendors and/or even terminals.

More particularly, location information used in providing differential location services can exist in multiple formats, e.g., expressed as GPS, cell ID, place name, RFID tag, and the like. Due to the multiplicity of location information formats, conventional network-bound services typically do not suffice for providing differential location triggers. Various mapping services, such as MapQuest or MapPoint .NET, do provide transformation of certain location information, typically addresses or place names, into GPS-like coordinates (although MapQuest provides a map output rather than coordinates). Such mapping services also support differential location information, however, they do not support arbitrary location information such as cell ID or RFids. Also, such mapping services do not provide triggering certain actions based on differential location triggers. And whereas other mapping techniques, such as those provided in cellular networks (e.g., GSM) also provide some form of mapping services, they only support cellular-specific location information, such as cell ID and the respective geographic data. They do not provide triggers, and further do not support other non-cellular location information.

### SUMMARY OF THE INVENTION

In light of the foregoing background, embodiments of the present invention provide an improved system, method and computer program product for providing differential location services. According to embodiments of the present invention, a service provider is capable of providing the differential location services based upon the location of a terminal relative to a specified geographic area. Advantageously, the service provider may receive the location of the terminal and/or the specified geographic area, where one or both are defined in a manner independent of a specific format, which may be a format specified by the terminal and/or the service provider. More particularly, the location of the terminal and/or the specified geographic area can be defined in a manner independent from any specific access technology or location definition. In this regard, the service provider can receive the location of the terminal and/or the specified geographic area such that one or both can be transformed to thereby define one or both in a predetermined manner (e.g., geographic (X, Y, Z) coordinates).

According to one aspect of the present invention, a system is presented for providing differential location service to a terminal. The system includes a service provider and a mapping processor. The service provider is capable of receiving a request for a differential location service from the terminal at least partially over a wireless network. The request includes a geographic area defined independent of a specific format, and in this regard, the mapping processor is capable of receiving the geographic area from the service provider. Thereafter, the mapping processor can transform the geographic area of the request to thereby define the geographic area in a predetermined manner. The mapping processor can send the geographic area defined in the predetermined manner to the service provider. Upon receiving the geographic area defined in the predetermined manner, the service provider can determine whether to provide the requested differential location service based upon a comparison of a current location of the terminal and the geographic area defined in the predetermined manner.

To provide the differential location service, the service provider can be capable of obtaining a current location of the terminal, such as from a location provider. More particularly, the service provider can obtain the current location of the terminal such that the mapping processor can thereafter transform the current location of the terminal to thereby define the current location in the predetermined manner. The service provider can then be capable of comparing the current location of the terminal defined in the predetermined manner with the geographic area defined in the predetermined manner, and thereafter determine whether to provide the requested differential location service based upon the comparison.

In addition to the geographic area, the request can include any one or more of a number of different pieces of information. For example, the request can further include a validity time to subscribe to a differential location service. In such instances, the service provider can be capable of determining if the subscription is valid based upon a current time and the validity time. The service provider can then provide the requested differential location service when the subscription is valid. As another example, the request can further include an action. When the request includes an action, the service provider can be capable of providing the requested differential location service by executing the action based upon a comparison of a current location of the terminal and the geographic area defined in the predetermined manner.

As yet another example, the request can further include a trigger condition. In such instances, the service provider can be capable of providing the requested differential location service if, based upon a comparison of the current location of the terminal and the geographic area, the current location of the terminal satisfies the trigger condition. In a more particular example, the trigger condition can specify either “outside” or “inside.” Then, when the trigger condition specifies “outside,” the service provider can be capable of providing the requested differential location service if the current location of the terminal is outside the geographic area. On the other hand, when the trigger condition specifies “inside,” the service provider can be capable of providing the requested differential location service if the current location of the terminal is inside the geographic area.

According to another aspect of the present invention, a method is presented for providing a differential location service to a terminal. Embodiments of the present invention therefore enable service providers to provide differential location services independent of a specified location information format, and without utilizing a pre-existing, specific location service infrastructure. Advantageously, and in accordance with embodiments of the present invention, the service provider bears the burden of supporting a variety of different location formats, thus reducing the resources required of the terminal to receive differential location services in accordance with conventional techniques. Hence, the terminal can receive differential location services by merely providing a geographic area, and possibly terminal location, in any of a number of different formats without bothering to transform the location geographic area or terminal location, and without comparing the terminal location with the geographic area. Therefore, the systems and methods of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a cellular network and a data network to which a terminal is bi-directionally coupled through wireless RF links;

FIG. 2 is a schematic block diagram of a terminal comprising a mobile station according to one embodiment of the present invention;

FIG. 3 is a control flow diagram illustrating various steps in a method of providing differential location services according to one embodiment of the present invention; and

FIG. 4 is a flow chart illustrating various steps in a method of providing differential location services according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

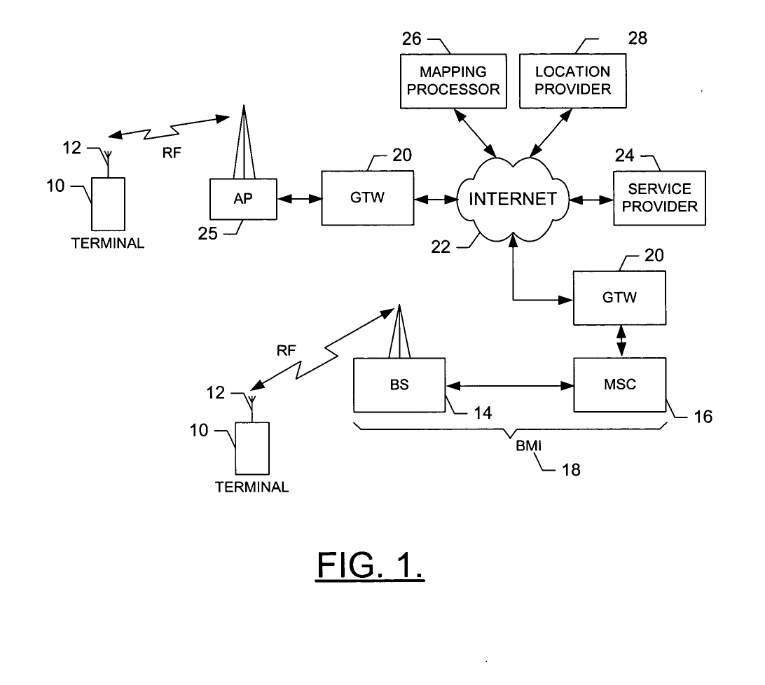

Referring to FIG. 1, an illustration of one type of terminal and system that would benefit from the present invention is provided. The system, terminal and method of the present invention will be primarily described in conjunction with mobile communications applications. It should be understood, however, that the system and method of the present invention can be utilized in conjunction with a variety of other applications, both in the mobile communications industries and outside of the mobile communications industries. For example, the system and method of the present invention can be utilized in conjunction with wireline and/or wireless network (e.g., Internet) applications including communicating in accordance with the Hypertext Transfer Protocol (HTTP).

As shown, a terminal 10 may include an antenna 12 for transmitting signals to and for receiving signals from a base site or base station (BS) 14. The base station is a part of a cellular network that includes elements required to operate the network, such as a mobile switching center (MSC) 16. As well known to those skilled in the art, the cellular network may also be referred to as a Base Station/MSC/Interworking function (BMI) 18. In operation, the MSC is capable of routing calls and messages to and from the terminal when the terminal is making and receiving calls. The MSC also provides a connection to landline trunks when the terminal is involved in a call. Further, the MSC can, but need not, be coupled to a server GTW 20 (Gateway).

The MSC 16 can be coupled to a data network, such as a local area network (LAN), a metropolitan area network (MAN), and/or a wide area network (WAN). The MSC can be coupled to the data network directly, or if the system includes a GTW 20 (as shown), the MSC can be coupled to the network via the GTW. In one typical embodiment, for example, the MSC is coupled to the GTW, and the GTW is coupled to a WAN, such as the Internet 22. In turn, devices such as processing elements (e.g., personal computers, server computers or the like) can be coupled to the terminal 10 via the Internet. For example, the processing elements can include one or more processing elements associated with a service provider 24, as well as one or more processing elements associated with one or more mapping processors 26, and/or one or more location providers 28, one of each being illustrated in FIG. 1.

As explained below, the service provider 24 is capable of providing one or more differential location services to one or more terminals 10 based upon the current locations of the terminals relative to one or more specified geographic areas. In turn, then, the mapping processor 26 is capable of transforming the current locations and/or the specified geographic areas to define the current locations and/or specified geographic areas in a predetermined manner, such as a set of geographic (X, Y, Z) coordinates. Each mapping processor can be capable of receiving, and thereafter transforming one or more current locations and/or specified geographic areas defined in one or more different manners. As shown and described, the service provider, mapping processor and the location provider 28 are distributed from one another, such as across the Internet 22. It should be understood, however, that any one or more of the service provider, mapping processor and location provider can be logically co-located with any one or more of the service provider, mapping processor and location provider.

In addition to the service provider 24, mapping processor 26 and/or the location provider 28, the network may be coupled to one or more wireless access points (APs) 25. In turn, the APs may be wirelessly coupled to one or more terminals 10. As will be appreciated, by directly or indirectly connecting the terminals and the other devices (e.g., origin server) to the Internet, the terminals can communicate with the other devices and with one another, such as according to the Hypertext Transfer Protocol (HTTP), to thereby carry out various functions of the terminal.

The service provider 24 can comprise a logical functional entity capable of receiving information regarding the location of one or more terminals 10, and thereafter providing one or more differential location services to the terminals based upon the locations of the respective terminals. The service provider can comprise an entity that is external to the wireless communication network, as shown in FIG. 1 (coupled to the wireless communication network via the Internet 22). Alternatively, the service provider can comprise an internal client, i.e., reside in any entity or node (including the terminal) within the wireless communication network.

Information regarding the location of the terminals 10 can be used by the service provider 24 to provide any of a number of different differential location services for any of a number of different purposes. For example, the service provider may transmit location-related information to the terminal 10 that is pertinent to a location within a particular geographic area, such as on weather, traffic, hotels, restaurants, or the like. Also, for example, the service provider may transmit messages to the terminal and/or one or more specified recipients, when the terminal is located in a predefined relation with respect to a geographic area. In addition, for example, the service provider may record anonymous location information (i.e., without any mobile station identifier), such as for traffic engineering and statistical purposes. Further, the service provider may enhance or support any of a number of supplementary services, such as an Intelligent Network (IN) service, bearer service and/or tele-service subscribed to by the terminal user.

There are also several other possible commercial and non-commercial differential location services that may be provided by the service provider 24 based upon the location of the terminal 10. Such possible applications include, for example, different local advertisement and information distribution schemes (e.g. transmission of information directed to those mobile users only who are currently within a certain geographic area), geographic area-related WWW-pages (such as time tables, local restaurant, shop or hotel guides, maps, local advertisements, etc.) for the users of mobile data processing devices, and tracking of terminal users by anyone who wishes to receive this information. An application requiring real-time location regarding the movement of a terminal is a terminal movement prediction feature that the wireless communication network may utilize, for example, in dynamic network resource allocation. There are still various other possible differential location services capable of being provided by the service provider 24.

As indicated above, and explained below, to provide the location of the terminal 10 to the service provider 24, the service provider can be coupled to a location provider 28. In this regard, the location provider can be arranged to receive a request for location information, such as from the service provider. In such instances, the request for location information can include the identity of the terminal such as an international mobile subscriber identifier (IMSI), or a temporary identifier such as a temporary international mobile subscriber identifier (TIMSI). The location provider may respond to a location request from a service provider with location information for a target terminal 10 specified by the service provider. The location provider may therefore provide the service provider, on request or periodically, the current or most recent location (if available) of the target terminal or, if the location determination fails, an error indication and optionally the reason for the failure. For more information on one type of location provider, often referred to as a location server, see European telecommunications Standards Institute (ETSI) technical specification entitled: Location Services (3GPP TS23.171 and GSM 03.71), the contents of which are hereby incorporated by reference in its entirety.

The location provider 28 can be implemented in the core network and be arranged to determine the location of the terminal 10 in any of a number of different manners. For example, the location provider can be capable of determining the location of the terminal based upon location information from the wireless communication network via the MSC 16 and/or a serving general packet radio service support node (SGSN) (not shown). Additionally or alternatively, for example, the location provider can determine the location of the terminal in accordance with any of a number of other techniques including, for example, triangulation, Global Positioning System (GPS), Assisted GPS (A-GPS), Time of Arrival (TOA), Observed Time Difference of Arrival (OTDOA) or the like, as such are well known to those skilled in the art.

The location of the terminal 10 can be defined by the location provider 28 in any of a number of different manners. For example, the location can be defined as a logical location (e.g., Boston, Boston Common, Central Park, etc.). Also, for example, the location can be defined as a set of geographic (X, Y, Z) coordinates, where the geographic (X, Y, Z) coordinates may, but need not, include a Z coordinate. In addition, for example, the location can be defined as a set of geographic latitude and longitude coordinates. Further, the location can be defined by a cell ID, where the location can be defined as a cell identifier that identifies a geographic area through the coverage area of the cell (e.g., GSM cell) associated with the cell ID. As yet another example, the location may be defined by an RF identifier (RFID) (e.g., 32-bit identifier). In such instances, the location can be defined by an RFID, and may also be defined to include a name or other identifier of a provider associated with the RFID. In this regard, a location can be “tagged” by the terminal 10, as such by an RFID tag at a respective location, and thereafter recalled based upon the RFID provided by the RFID tag and the associated provider.

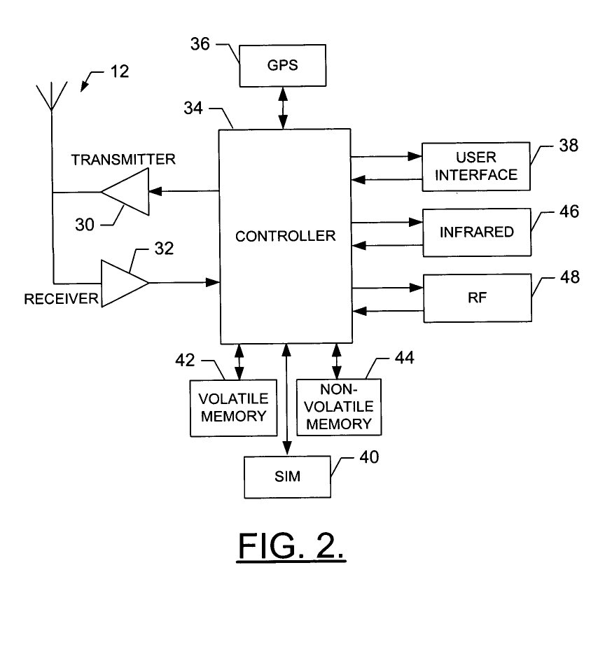

Although shown and described herein as being coupled to the Internet 22, it should be appreciated that the location provider 28 may be logically located anywhere in the data network and/or wireless communications network. Also, the location provider may be distributed between several elements of the network, or may be implemented in a single element. Further, the location provider may also be an external node to the wireless communications network. According to one embodiment, for example, the terminal 10 or user equipment includes the location provider (e.g., GPS sensor 36—see FIG. 2), and thus provides the location provider functionality. In such instances, the terminal is capable of generating and transporting location information thereof to the service provider 24.

Reference is now drawn to FIG. 2, which illustrates a block diagram of one type of terminal 10, a mobile station, that would benefit from the present invention. It should be understood, however, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of terminals, such as pagers, personal computers, laptop computers, personal digital assistants (PDAs) and other types of voice and text communications systems, can readily employ the present invention. In this regard, the terminal any of a number of different terminals that include a processing element or controller, and that are capable of communicating over the Internet 22 either directly or indirectly, such as via the wireless APs 25 and/or the BMI 18.

As shown, the mobile station includes a transmitter 30, a receiver 32, and a controller 34 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 34 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. Further, the controller may include the functionally to operate one or more software programs, which may be stored in memory (described below). For example, the controller may be capable of operating a connectivity program, such as a conventional Web browser. The connectivity program may then allow the mobile station to transmit and receive Web content, such as according to HTTP, for example. Also, for example, the controller may be capable of operating a location services client that allows the mobile station to request, and thereafter, receive services based upon the location of the mobile station, as described in more detail below.

The mobile station also comprises a user interface 38 that may include a conventional earphone or speaker, a ringer, a microphone, a display, and a user input interface, all of which are coupled to the controller 34. The user input interface, which allows the mobile station to receive data, can comprise any of a number of devices allowing the mobile station to receive data, such as a keypad, a touch display (not shown) or other input device. In embodiments including a keypad, the keypad includes the conventional numeric (0-9) and related keys (#, *), and other keys used for operating the mobile station. In addition, the mobile station can include a positioning sensor, such as a global positioning system (GPS) sensor 36. In this regard, the GPS sensor is capable of determining a location of the mobile station, such as longitudinal and latitudinal directions of the mobile station.

The mobile station can also include memory, such as a subscriber identity module (SIM) 40, a removable user identity module (R-UIM) or the like, which typically stores information elements related to a mobile subscriber. In addition to the SIM, the mobile station can include other memory. In this regard, the mobile station can include volatile memory 42, such as volatile Random Access Memory (RAM) including a cache area for the temporary storage of data. The mobile station can also include other non-volatile memory 44, which can be embedded and/or may be removable. The memories can store any of a number of pieces of information, and data, used by the mobile station to implement the functions of the mobile station. For example, the memories can include an identifier, such as an international mobile equipment identification (IMEI) code, capable of uniquely identifying the mobile station, such as to the MSC 16.

The mobile station can further include an infrared transceiver 46 or another local data transfer device so that data can be shared with and/or obtained from other devices such as other mobile stations, car guidance systems, personal computers, printers, printed materials including barcodes and the like. The sharing of data, as well as the remote sharing of data, can also be provided according to a number of different techniques. For example, the mobile station may include a radio frequency (RF) transceiver 48 capable of sharing data with other radio frequency transceivers, and/or with a Radio Frequency Identification (RFID) transponder tag, as such is known to those skilled in the art. Additionally, or alternatively, the mobile station may share data using Bluetooth brand wireless technology developed by the Bluetooth Special Interest Group. Further, although not shown, the mobile station may include a barcode reader such that the mobile station may receive data according to barcode data transfer techniques.

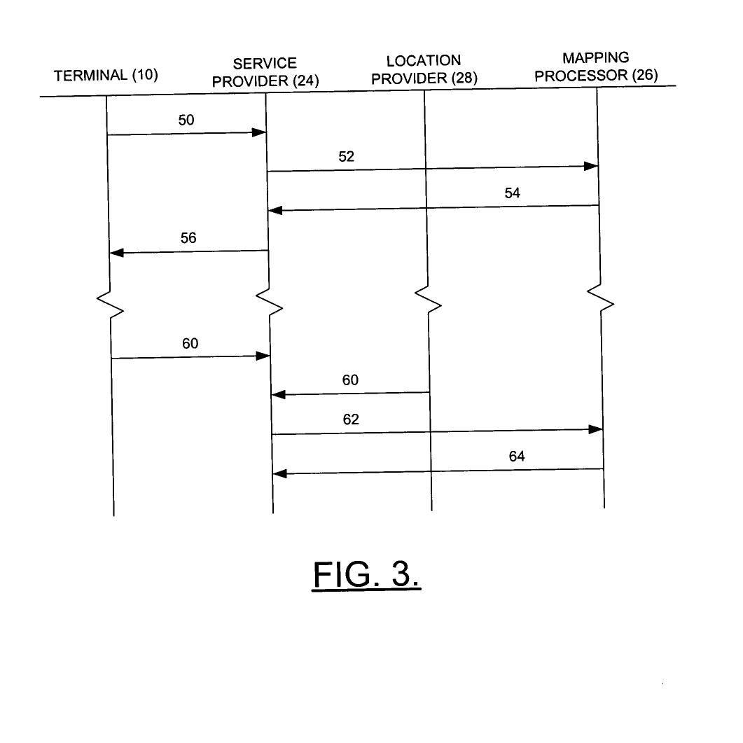

As indicated in the background section, conventional techniques for providing location services are typically bound to specified operators or systems as such techniques rely on dedicated network functionality. And as such, such conventional techniques typically cannot adequately provide location services across networks, operators, vendors and/or even terminals. In order to address the shortcomings of these conventional approaches, reference is now made to FIG. 3, which illustrates a control flow diagram according to exemplar methods of providing location information in the context of delivering location-based services. Advantageously, according to embodiments of the present invention, a service provider can be capable of providing location services, such as differential location services, independent of a specified location information format, and without utilizing a pre-existing, specified location service infrastructure.

According to the embodiment of the present invention shown in FIG. 3, a method of providing a differential location service begins with the terminal 10 requesting a differential location service from a service provider 24. To request the differential location service according to this embodiment, the terminal can send a request message 50 to the service provider. The request message can include one or more requests for one or more differential location services. Also, the request message can be formatted in any of a number of different manners, such as in accordance with ICMP (Internet Control Message Protocol), UDP (User Datagram Protocol) or SOAP (Simple Object Access Protocol).

The request message 50 can include any of a number of different pieces of information, but in one embodiment, the request message includes an action, a trigger, a geographic area and a validity time. The information in the request message can be formatted in any of a number of different manners, such as in accordance with Resource Description Framework (RDF) or XML (Extensible Markup Language). In the request message, the action defines the service provided by the service provider, where the service can be expressed as an action to be executed by the service provider. The action can comprise any of a number of different actions. For example, as explained below, the action can comprise sending a message to the terminal and/or one or more specified receivers.

The trigger in the request message 50 typically defines one or more conditions that must be satisfied for the service provider to execute the defined action. The trigger can define any of a number of different trigger conditions. In one advantageous embodiment, for example, the trigger defines a location of the terminal 10 relative to a geographic area, which can be defined by the geographic area included in the request message. For example, the trigger can specify “inside” or “outside.” In such instances, the trigger “inside” specifies a condition that is satisfied when the terminal is located inside the specified geographic area, while the trigger “outside” defines a condition that is satisfied when the terminal is located outside the specified geographic area.

The geographic area specified in the request message 50 typically defines a geographic area that the service provider 24 can compare with the location of the terminal 10, such as to determine whether the location of the terminal satisfies the specified trigger condition. The geographic area can be defined in any of a number of different manners. For example, the geographic area can be defined as a location and an area relative to the location. In this regard, the location can be defined in any of a number of different manners, such as in any of the different manners of defining the location of the terminal 10 described above (logical area, geographic coordinates, cell ID, RFID, etc.). Like the location, the area relative to the location can be defined in any of a number of different manners capable of defining a geographic area. For example, the area can be defined as a radius from the location (e.g., five mile radius), and/or a distance from the location (e.g., ΔX, ΔY and/or ΔZ; Δ-longitude and/or Δ-latitude, etc.).

As may also be specified in the request message 50, the validity time comprises a condition including one or more times, and/or one or more periods of time, at which the service provider 24 can compare the location of the terminal 10 with the specified geographic area to determine if the location of the terminal satisfies the specified trigger. The validity time can be specified in any of a number of different formats, such as in accordance with the iCalendar specification, as such is well known to those skilled in the art. The validity time can also be defined in any of a number of different manners, such as by one or more absolute or relative times/periods of time along with one or more defined dates. For example, the validity time can be specified as the absolute time/date “1:45 pm today.” Also, for example, the validity time can be specified as the absolute period of time/date “2:00 pm to 3:00 pm today.” As will be appreciated, in instances in which the validity time includes a period of time, the period of time can, but need not, specify a time increment (e.g., 20 minute increments) over the period of time.

In instances in which the validity time includes more than one time and/or period of time, the validity time can be defined as a number of individual times and/or periods of time with each including an associated date, or as a single time and/or period of time with a number of dates. For example, the validity time can be specified as the absolute times, “1:00 pm Monday, 1:00 pm Tuesday, and 1:00 pm Wednesday,” or as the absolute periods of time, “1:00 pm-2:00 pm Monday-Friday.” In addition, the validity time can be defined as an individual time and/or period of time that includes a periodicity. For example, the validity time can be specified as “1:45 each Monday,” or as “1:00 pm-2:00 pm each Monday.”

As will also be appreciated, in addition to one or more times and/or periods of time, the validity time may also include one or more ending delimiters, particularly in instances in which the validity time includes more than one time and/or period of time. The ending delimiters, like the times/periods of time, can be defined in any of a number of different manners, such as by one or more absolute or relative delimiters. In this regard, an ending delimiter can specify a specific number of times and/or periods of time, a unit of time including one or more times and/or periods of time (e.g., hour, day, week, month, year, etc.) or the like. For example, the validity time can be specified as “1:45 pm each Monday×4,” or as “1:45 pm each Monday in April.” In the preceding examples, “1:45 pm” defines an absolute time, “each Monday” defines a periodicity, “today×4” defines a delimiter that specifies four Mondays beginning with the current date, and “in April” defines a delimiter that specifies the month of April.

In addition to, or in lieu of, specifying a specific number of times and/or periods of time, an ending delimiter can specify a condition that, when satisfied, provides an end to the validity time. The condition can comprise any of a number of different conditions capable of being interpreted by, or communicated to, the service provider 24. For example, the validity time can be specified as “1:00 pm-3:00 pm in 20 minute increments until action executed.” In the preceding example, “1:00 pm-2:00 pm defines a period of time, and “in 20 minute increments” defines an increment over the period of time. Also in the preceding example, “until action executed” defines a condition specifying that the validity time end when the service provider 24 executes the specified action in the request message 50.

Irrespective of the information provided in the request message 50, once the service provider 24 receives the request message, the service provider can enter a subscription for the terminal 10 based upon the request message, where the subscription includes the information (i.e., subscription information) included in the request message. Before the service provider can enter the subscription, however, the service provider may be required to transform the specified geographic area, including the location and possibly the area relative to the location that may collectively define the geographic area. In this regard, the service provider may be required to transform the geographic area to thereby define the geographic area in a manner that permits the service provider to subsequently compare the location of the terminal with the geographic area. In one advantageous embodiment, for example, the service provider can transform the geographic area into a set of geographic (X, Y, Z) coordinates, unless the request message 50 already defined the geographic area as a set of geographic coordinates. Hence, if the request message defined a geographic area in a manner other than geographic (X, Y, Z) coordinates, the service provider can initiate a transformation of the specified geographic area.

The service provider 24 can initiate transformation of the geographic area in any of a number of different manners. According to one advantageous embodiment, for example, the service provider initiates transformation by communicating with a mapping processor 26. More particularly, the service provider can send a transformation request 52 to the mapping processor, where the transformation request includes the geographic area as defined in the request message 50. The service provider can send the transformation request to any of a number of different mapping processors. In one embodiment, however, the service provider is capable of selecting a mapping processor based upon the manner the request message defines the geographic area, and thereafter sending the transformation request to the respective mapping processor.

After receiving the transformation request 52, the mapping processor 26 can transform the geographic area into (X, Y, Z) coordinates. The mapping processor can then return the transformed geographic area to the service provider 24, such as in a response message 54. As will be appreciated, like the request message, the transformation request and response message can be formatted in any of a number of different manners, such as in accordance with ICMP, UDP or SOAP. Also, the information in the transformation request and response message can be formatted in any of a number of different manners, such as in accordance with RDF or XML.

After receiving the geographic area defined as a set of geographic (X, Y, Z) coordinates (whether from the terminal 10 in the request message 50 or from the mapping processor 26 in the response message 54), the service provider 24 can enter the subscription. Additionally, the service provider can store the subscription information provided in the request message, including the geographic area defined as a set of geographic (X, Y, Z) coordinates. After entering the subscription, then, the service provider can send an accept message 56 to the terminal 10 notifying the terminal that the service provider has accepted the entered subscription, where the accept response can, but need not, include a subscription identifier associated with the respective subscription.

Advantageously, and in accordance with embodiments of the present invention, after entering the subscription, the service provider 24 can compare the location of the terminal 10 with the specified geographic area in accordance with the specified validity time. By comparing the location of the terminal with the specified area, the service provider can determine when to provide the respective differential location service to the terminal. As will be appreciated, before comparing the location of the terminal with the geographic area, the service provider can receive the location of the terminal, such as from the terminal itself and/or from the location provider 28. Then, based upon the comparison, the service provider can execute the specified action if the location of the terminal satisfies the specified trigger.

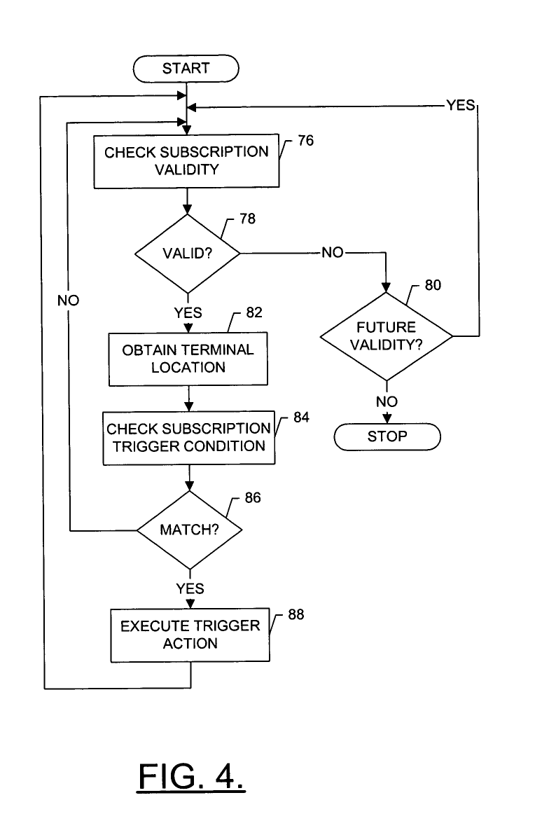

More particularly, referring to FIG. 4, after entering the subscription, the service provider 24 can check the validity time of the subscription against the current time/date to thereby determine if the subscription is valid for the current time, as shown in blocks 76 and 78. For example, when the validity time is defined by a specific time/date, the service provider can check to determine if the current time/date matches the specific time/date. Also for example, when the validity time is defined by a specific period of time, the service provider can check to determine if the current time/date is within the specific period of time. If the service provider determines that the subscription is not valid for the current time, the service provider can determine if the subscription has any future validity, as shown in block 80. And if the subscription does have any future validity, the service provider can continue to check the validity time. If the subscription does not have any future validity, however, the service provider can cease to operate in accordance with the subscription, and can delete the subscription information, if so desired.

As shown in block 82, if the service provider 24 determines that the subscription is valid for the current time, the service provider can obtain the location of the terminal 10. The service provider can obtain the location of the terminal in any of a number of different manners, such as from the terminal itself or from the location provider 28. For example, the terminal can be responsible for determining its current location, and sending the current location to the service provider. In such instances, the terminal can determine its current location in any of a number of different manners. For example, the terminal can be capable of determining its current location based upon information obtained by the access technology of the terminal, such as the current cell ID. Additionally, or alternatively, the terminal can determine its current location from sources local to, or distributed from, the terminal. For example, the terminal can determine its current location from a GPS sensor, such as GPS sensor 36 (see FIG. 2). Additionally or alternatively, for example, the terminal can determine its current location from one or more RF identifiers (described above) or the like.

In addition to, or in lieu of, the terminal 10 determining its current location and sending its current location to the service provider 24, the location provider 28 can be responsible for determining the current location. In this regard, the location provider can determine the location of the terminal, such as in accordance with any of the number of manners described above. And whereas the location provider can determine the location of the terminal without interaction with the terminal, in one advantageous embodiment, the location provider determines the location of the terminal based upon an authorization of the terminal. For example, the location provider can determine the location of the terminal in accordance with an authorization, which the service provider can receive from the terminal and thereafter pass to the location provider as an authorization token.

As shown in FIG. 3, irrespective of how the terminal 10 or location provider 28 determines the current location of the terminal, the terminal and/or the location provider can send a location message 60 to the service provider 24, where the location message includes the current location of the terminal, and may also identify how the location is defined. The terminal or location provider can initiate sending the location message to the service provider, such as by sending a location message with a given periodicity or based upon changes in the location of the terminal. Additionally, or alternatively, the service provider can initiate reception of the location message, such as by sending a location request to the terminal or location provider when the service provider determines the subscription is valid.

Like the location specified by the geographic area in the request message 50, the current location of the terminal 10 can be defined by the location message 60 in any of a number of different manners, including any one of the manners described above for specifying the geographic area. In this regard, in instances in which the location message defines the current location of the terminal in a manner other than by a set of geographic (X, Y, Z) coordinates, the service provider 24 can initiate a transformation of the current location. The service provider can initiate transformation of the current location information in any of a number of different manners, but in one advantageous embodiment, the service provider sends a transformation request 62 to the mapping processor 26.

As with transformation request 52, the service provider can send transformation request 62 to any of a number of different mapping processors. In one embodiment, for example, the service provider selects a mapping processor based upon the manner the location message 60 defines the geographic area, and thereafter sends the transformation request to the respective mapping processor. As with transformation request 52, once the mapping processor receives transformation request 62, the mapping processor can transform the location of the terminal into a set of geographic (X, Y, Z) coordinates. The mapping processor can then return the transformed terminal location to the service provider, such as in a response message 64 that may comprise a message similar to response message 54.

Again referring to FIG. 4, after obtaining the location of the terminal 10, the service provider 24 can compare the location of the terminal with the geographic area to check if the location of the terminal satisfies the trigger condition specified in the subscription information, as shown in block 82. For example, if the trigger specifies the location of the terminal “outside” the specified geographic area, the service provider can compare the location of the terminal with the geographic area to determine whether the terminal is located outside the geographic area.

As shown in block 84, if the location of the terminal 10 does not satisfy the specified trigger, the service provider 24 can again check the validity of the subscription, and if the subscription is valid for the current time, obtain the location of the terminal and compare the location of the terminal with the specified geographic area to determine if the location of the terminal satisfies the trigger condition. If, on the other hand, the location of the terminal does satisfy the specified trigger, the service provider can perform the action specified in the subscription information. Thereafter, the method can repeat, typically beginning with the service provider again checking the validity of the subscription (see block 74).

As an example of one application of the system and method of one embodiment of the present invention, consider a service provider 24 capable of sending a “running late” message to specified participants of a predefined appointment. In this example, consider that a software application operating on the terminal 10 is capable of accessing calendar data of a calendar application, also operating on the terminal. For instance, the software application may be capable of accessing calendar data such as appointment locations and times, as well as appointment attendants, for one or more appointments. In this example, then, for each appointment, the software application may desire to have a “running late” message sent to the attendants of the respective appointment if, at a specified “reminder time” before the respective appointment time, a user of the terminal is outside a specified “vicinity” of the respective appointment location (as determined based upon the location of the terminal).

To direct the service provider 24 to send such “running late” messages, the software application operating on the terminal 10 can send a request message 50 to the service provider. In this regard, the request message can include an action such as, for example, “send ‘running late’ message to appointment participants.” The request message can also include a trigger comprising “outside,” and a geographic area specifying the appointment location and the “vicinity.” Further, the request message can include a validity time comprising the “reminder time,” where the reminder time can be an absolute time or a time relative to the appointment time.

Upon receipt of the request message from the terminal 10, the service provider 24 can enter a subscription including the subscription information in the request message. Before entering the subscription, however, the service provider may communicate with the mapping processor 26 to transform the appointment location, and possibly the “vicinity,” into a set of geographic (X, Y, Z) coordinates. After entering the subscription, the service provider can repeatedly check the validity of the subscription based upon the current time and the validity time (i.e., “reminder time”). Then, when the service provider determines that the subscription is valid (i.e., current time matches the “reminder time”), the service provider can obtain the location of the terminal. Upon obtaining the location of the terminal, as explained above, the service provider can again communicate with the mapping processor to transform the location of the terminal into geographic (X, Y, Z) coordinates.

After obtaining the location of the terminal 10 defined as a set of geographic (X, Y, Z) coordinates (whether from the terminal or location provider 28, or from the mapping processor 26), the service provider can compare the location of the terminal with the geographic area (defined by the appointment location and “vicinity”) to check if the terminal is located “outside” the “vicinity” of the appointment location. Then, if the terminal is located “outside” the “vicinity,” the trigger condition is satisfied, and the service provider can send the “running late” message to the appointment participants. After sending the “running late” message, or if the terminal is not located “outside” the “vicinity” (i.e., the terminal is located inside the “vicinity” of the appointment location), the service provider can again check the validity time. But because the validity time defined a single time, neither the current time nor any future time will match the validity time. As such, the service provider can cease to operate in accordance with the subscription.

As shown and described above, the location of the terminal and the geographic area can be defined in any of a number of different manners. As will be appreciated, according to advantageous embodiments of the present invention, the location of the terminal and the geographic area can be provided to the service provider 24 independent of a specific definition. As also shown and described above, the mapping processor 26 is capable of transforming the location of the terminal and/or the geographic area into sets of geographic (X, Y, Z) coordinates. It should be understood, however, that the mapping processor need not transform the location of the terminal and/or the geographic area into geographic (X, Y, Z) coordinates. In this regard, the mapping processor can be capable of transforming the location of the terminal and/or the geographic area into any definition of the same that permits the service provider to compare the location of the terminal with the geographic area. For example, the mapping processor can transform the location information into latitude and longitude coordinates.

Embodiments of the present invention therefore enable service providers to provide differential location services independent of a specified location information format, and without utilizing a pre-existing, specified location service infrastructure. Also, by including the service provider functionality in a service provider distributed from the terminal, the terminal need not discover or search for appropriate transformation services to determine the differential location from the desired place. In this regard, in accordance with embodiments of the present invention, the burden of supporting a variety of different location formats is placed on the service provider. Hence, the terminal can receive differential location services by merely providing a geographic area, and possibly terminal location, in any of a number of different formats without bothering to transform the location geographic area or terminal location, and without comparing the terminal location with the geographic area.

According to various embodiments of the present invention, the system, terminal 10, service provider 24, mapping processor 26 and/or location provider 28 of embodiments of the present invention generally operate under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 3 and 4 are a control flow diagram and flowchart of a method, system and program product according to embodiments of the invention. It will be understood that each block or step of the flow diagram and flowchart, and combinations of blocks or steps in the flow diagram and flowchart, can be implemented by computer program instructions. These computer program instructions may be loaded onto a computer or other programmable apparatus, such as the terminal 10, to produce a machine, such that the instructions which execute on the computer or other programmable apparatus create means for implementing the functions specified in the flow diagram and flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flow diagram and flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow diagram and flowchart block(s) or step(s).

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of providing a differential location service to a terminal, the method comprising:
sending a request for a differential location service, the request including a geographic area defined independent of a specific format, wherein the request is sent at least partially over a wireless network;
receiving the request, and thereafter transforming the geographic area of the request to thereby define the geographic area in a predetermined manner; and
determining whether to provide the requested differential location service based upon a comparison of a current location of the terminal and the geographic area defined in the predetermined manner.

2. A method according to claim 1, wherein determining whether to provide the requested differential location service comprises:
obtaining a current location of the terminal, and thereafter transforming the current location of the terminal to thereby define the current location in the predetermined manner;
comparing the current location of the terminal defined in the predetermined manner with the geographic area defined in the predetermined manner; and
determining whether to provide the requested differential location service based upon the comparison.

3. A method according to claim 1, wherein sending a request comprises sending a request further including a validity time to subscribe to a differential location service, and wherein determining whether to provide the requested differential location service comprises:
determining if the subscription is valid based upon a current time and the validity time; and
providing the requested differential location service when the subscription is valid.

4. A method according to claim 1, wherein sending a request comprises sending a request further including a trigger condition, and wherein determining whether to provide the requested differential location service comprises providing the requested differential location service if, based upon a comparison of a current location of the terminal and the geographic area, the current location of the terminal satisfies the trigger condition.

5. A method according to claim 4, wherein sending a request comprises sending a request including a trigger condition specifying one of “outside” and “inside,” wherein determining whether to provide the requested differential location service comprises providing the requested differential location service if the current location of the terminal is outside the geographic area when the trigger condition specifies “outside,” and providing the requested differential location service if the current location of the terminal is inside the geographic area when the trigger condition specifies “inside.”

6. A method according to claim 1, wherein sending a request comprises sending a request further including an action, and wherein determining whether to provide the requested differential location service comprises determining whether to execute the action based upon a comparison of a current location of the terminal and the geographic area defined in the predetermined manner.

7. A method according to claim 6, wherein sending a request comprises sending a request further including a validity time and a trigger condition, and wherein determining whether to provide the requested differential location service comprises:
determining if the subscription is valid based upon a current time and the validity time; and if the subscription is valid,
obtaining a current location of the terminal, and thereafter transforming the current location of the terminal to thereby define the current location in the predetermined manner;
comparing the current location of the terminal defined in the predetermined manner with the geographic area defined in the predetermined manner; and
executing the action if, based upon the comparison, the current location of the terminal satisfies the trigger condition.

8. A system for providing a differential location service to a terminal, the system comprising:
a service provider capable of receiving a request for a differential location service from the terminal at least partially over a wireless network, the request including a geographic area defined independent of a specific format; and
a mapping processor capable of receiving the geographic area from the service provider, wherein the mapping processor is capable of transforming the geographic area of the request to thereby define the geographic area in a predetermined manner, and thereafter sending the geographic area defined in the predetermined manner to the service provider,
wherein the service provider is also capable of determining whether to provide the requested differential location service based upon a comparison of a current location of the terminal and the geographic area defined in the predetermined manner.

9. A system according to claim 8, wherein the service provider is capable of obtaining a current location of the terminal such that the mapping processor can thereafter transform the current location of the terminal to thereby define the current location in the predetermined manner, wherein the service provider is then capable of comparing the current location of the terminal defined in the predetermined manner with the geographic area defined in the predetermined manner, and thereafter determining whether to provide the requested differential location service based upon the comparison.

10. A system according to claim 8, wherein the request further includes a validity time to subscribe to a differential location service, and wherein the service provider is capable of determining if the subscription is valid based upon a current time and the validity time, and capable of providing the requested differential location service when the subscription is valid.

11. A system according to claim 8, wherein the request further includes a trigger condition, and wherein the service provider is capable of providing the requested differential location service if, based upon a comparison of a current location of the terminal and the geographic area, the current location of the terminal satisfies the trigger condition.

12. A system according to claim 11, wherein the trigger condition specifies one of “outside” and “inside,” wherein the service provider is capable of providing the requested differential location service if the current location of the terminal is outside the geographic area when the trigger condition specifies “outside,” and capable of providing the requested differential location service if the current location of the terminal is inside the geographic area when the trigger condition specifies “inside.”

13. A system according to claim 8, wherein the request further includes an action, and wherein the service provider is capable of determining whether to provide the requested differential location service by determining whether to execute the action based upon a comparison of a current location of the terminal and the geographic area defined in the predetermined manner.

14. A system according to claim 13, wherein the request further includes a validity time and a trigger condition, wherein the service provider is capable of determining if the subscription is valid based upon a current time and the validity time, and if the subscription is valid, the service provider is capable of obtaining a current location of the terminal such that the mapping processor can thereafter transform the current location of the terminal to thereby define the current location in the predetermined manner, wherein the service provider is then capable of comparing the current location of the terminal defined in the predetermined manner with the geographic area defined in the predetermined manner, and thereafter executing the action if, based upon the comparison, the current location of the terminal satisfies the trigger condition to thereby provide the requested differential location service.

15. A system for providing a differential location service, the system comprising:
a terminal capable of sending a request for a differential location service, the request including a geographic area defined independent of a specific format, wherein the terminal is capable of sending the request at least partially over a wireless network;
a service provider capable of receiving the request such that the geographic area can be transformed to thereby define the geographic area in a predetermined manner; and
a location provider capable of providing a current location of the terminal to the service provider such that the service provider is capable of determining whether to provide the requested differential location service based upon a comparison of the current location of the terminal and the geographic area defined in the predetermined manner.

16. A system according to claim 15, wherein the service provider is capable of receiving the current location of the terminal from the location provider such that the current location can be transformed to thereby define the current location in the predetermined manner, wherein the service provider is then capable of comparing the current location of the terminal defined in the predetermined manner with the geographic area defined in the predetermined manner, and thereafter determining whether to provide the requested differential location service based upon the comparison.

17. A system according to claim 15, wherein the request further includes a validity time to subscribe to a differential location service, and wherein the service provider is capable of determining if the subscription is valid based upon a current time and the validity time, and capable of providing the requested differential location service when the subscription is valid.

18. A system according to claim 15, wherein the request further includes a trigger condition, and wherein the service provider is capable of providing the requested differential location service if, based upon a comparison of a current location of the terminal and the geographic area, the current location of the terminal satisfies the trigger condition.

19. A system according to claim 18, wherein the trigger condition specifies one of “outside” and “inside,” wherein the service provider is capable of providing the requested differential location service if the current location of the terminal is outside the geographic area when the trigger condition specifies “outside,” and capable of providing the requested differential location service if the current location of the terminal is inside the geographic area when the trigger condition specifies “inside.”

20. A system according to claim 15, wherein the request further includes an action, and wherein the service provider is capable of determining whether to provide the requested differential location service by determining whether to execute the action based upon a comparison of a current location of the terminal and the geographic area defined in the predetermined manner.

21. A system according to claim 20, wherein the request further includes a validity time and a trigger condition, wherein the service provider is capable of determining if the subscription is valid based upon a current time and the validity time, and if the subscription is valid, the service provider is capable of receiving the current location of the terminal from the location provider such that the current location can be transformed to thereby define the current location in the predetermined manner, wherein the service provider is then capable of comparing the current location of the terminal defined in the predetermined manner with the geographic area defined in the predetermined manner, and thereafter executing the action if, based upon the comparison, the current location of the terminal satisfies the trigger condition to thereby provide the requested differential location service.

22. A computer program product for providing a differential location service to a terminal, the computer program product comprising a computer-readable storage medium having computer-readable program code portions stored therein, the computer-readable program code portions comprising:
a first executable portion for sending a request for a differential location service, the request including a geographic area defined independent of a specific format, wherein the request is sent at least partially over a wireless network;
a second executable portion for receiving the request;
a third executable portion for transforming the geographic area of the request to thereby define the geographic area in a predetermined manner; and
a fourth executable portion for determining whether to provide the requested differential location service based upon a comparison of a current location of the terminal and the geographic area defined in the predetermined manner.

23. A computer program product according to claim 22, wherein the fourth executable portion is adapted to determine whether to provide the requested differential location service by:
obtaining a current location of the terminal, and thereafter transforming the current location of the terminal to thereby define the current location in the predetermined manner;
comparing the current location of the terminal defined in the predetermined manner with the geographic area defined in the predetermined manner; and
determining whether to provide the requested differential location service based upon the comparison.

24. A computer program product according to claim 22, wherein the first executable portion is adapted to send a request further including a validity time to subscribe to a differential location service, and wherein the fourth executable portion is adapted to determine whether to provide the requested differential location service by determining if the subscription is valid based upon a current time and the validity time, and thereafter providing the requested differential location service when the subscription is valid.

25. A computer program product according to claim 22, wherein the first executable portion is adapted to send a request further including a trigger condition, and wherein the fourth executable portion is adapted to determine whether to provide the requested differential location service by providing the requested differential location service if, based upon a comparison of a current location of the terminal and the geographic area, the current location of the terminal satisfies the trigger condition.

26. A computer program product according to claim 25, wherein the first executable portion is adapted to send a request including a trigger condition specifying one of “outside” and “inside,” wherein the fourth executable portion is adapted to provide the requested differential location service if the current location of the terminal is outside the geographic area when the trigger condition specifies “outside,” and provide the requested differential location service if the current location of the terminal is inside the geographic area when the trigger condition specifies “inside.”

27. A computer program product according to claim 22, wherein the first executable portion is adapted to send a request further including an action, and wherein the fourth executable portion is adapted to determine whether to execute the action based upon a comparison of a current location of the terminal and the geographic area defined in the predetermined manner.

28. A computer program product according to claim 27, wherein the first executable portion is adapted to send a request further including a validity time and a trigger condition, and wherein the fourth executable portion is adapted to determine whether to provide the requested differential location service by:
determining if the subscription is valid based upon a current time and the validity time; and if the subscription is valid,
obtaining a current location of the terminal, and thereafter transforming the current location of the terminal to thereby define the current location in the predetermined manner;
comparing the current location of the terminal defined in the predetermined manner with the geographic area defined in the predetermined manner; and
executing the action if, based upon the comparison, the current location of the terminal satisfies the trigger condition.

29. A computer program product for providing a differential location service to a terminal, the computer program product comprising a computer-readable storage medium having computer-readable program code portions stored therein, the computer-readable program code portions comprising:
a first executable portion for receiving a request for a differential location service, the request including a geographic area defined independent of a specific format, wherein the request is received at least partially over a wireless network;
a second executable portion for initiating transformation the geographic area of the request to thereby define the geographic area in a predetermined manner; and
a third executable portion for determining whether to provide the requested differential location service based upon a comparison of a current location of the terminal and the geographic area defined in the predetermined manner.

30. A computer program product according to claim 29, wherein the third executable portion is adapted to determine whether to provide the requested differential location service by:
obtaining a current location of the terminal, and thereafter initiating transformation the current location of the terminal to thereby define the current location in the predetermined manner;
comparing the current location of the terminal defined in the predetermined manner with the geographic area defined in the predetermined manner; and
determining whether to provide the requested differential location service based upon the comparison.

31. A computer program product according to claim 29, wherein the first executable portion is adapted to receive a request further including a validity time to subscribe to a differential location service, and wherein the third executable portion is adapted to determine whether to provide the requested differential location service by determining if the subscription is valid based upon a current time and the validity time, and thereafter providing the requested differential location service when the subscription is valid.

32. A computer program product according to claim 29, wherein the first executable portion is adapted to receive a request further including a trigger condition, and wherein the third executable portion is adapted to determine whether to provide the requested differential location service by providing the requested differential location service if, based upon a comparison of a current location of the terminal and the geographic area, the current location of the terminal satisfies the trigger condition.

33. A computer program product according to claim 32, wherein the first executable portion is adapted to receive a request including a trigger condition specifying one of “outside” and “inside,” wherein the third executable portion is adapted to provide the requested differential location service if the current location of the terminal is outside the geographic area when the trigger condition specifies “outside,” and provide the requested differential location service if the current location of the terminal is inside the geographic area when the trigger condition specifies “inside.”

34. A computer program product according to claim 29, wherein the first executable portion is adapted to receive a request further including an action, and wherein the third executable portion is adapted to determine whether to execute the action based upon a comparison of a current location of the terminal and the geographic area defined in the predetermined manner.

35. A computer program product according to claim 34, wherein the first executable portion is adapted to receive a request further including a validity time and a trigger condition, and wherein the third executable portion is adapted to determine whether to provide the requested differential location service by:
determining if the subscription is valid based upon a current time and the validity time; and if the subscription is valid,
obtaining a current location of the terminal, and thereafter initiating transformation of the current location of the terminal to thereby define the current location in the predetermined manner;
comparing the current location of the terminal defined in the predetermined manner with the geographic area defined in the predetermined manner; and
executing the action if, based upon the comparison, the current location of the terminal satisfies the trigger condition.

36. A computer program product for providing a differential location service to a terminal, the computer program product comprising a computer-readable storage medium having computer-readable program code portions stored therein, the computer-readable program code portions comprising:
a first executable portion for sending a request for a differential location service, the request including a geographic area defined independent of a specific format, wherein the request is sent at least partially over a wireless network such that, upon receipt of the request, the geographic area of the request can be transformed to thereby define the geographic area in a predetermined manner, and wherein the request is sent such that it can be determined whether to provide the requested differential location service based upon a comparison of a current location of the terminal and the geographic area defined in the predetermined manner.

37. A computer program product according to claim 36, wherein the first executable portion is adapted to send the request such that it can be determined whether to provide the requested differential location service by:
obtaining a current location of the terminal, and thereafter transforming the current location of the terminal to thereby define the current location in the predetermined manner;
comparing the current location of the terminal defined in the predetermined manner with the geographic area defined in the predetermined manner; and
determining whether to provide the requested differential location service based upon the comparison.

38. A computer program product according to claim 36, wherein the first executable portion is adapted to send a request further including a validity time to subscribe to a differential location service such that it can be determined whether to provide the requested differential location service by determining if the subscription is valid based upon a current time and the validity time to thereby provide the requested differential location service when the subscription is valid.

39. A computer program product according to claim 36, wherein the first executable portion is adapted to send a request further including a trigger condition such that the requested differential location service can be provided if, based upon a comparison of a current location of the terminal and the geographic area, the current location of the terminal satisfies the trigger condition.

40. A computer program product according to claim 39, wherein the first executable portion is adapted to send a request including a trigger condition specifying one of “outside” and “inside” such that the requested differential location service can be provided if the current location of the terminal is outside the geographic area when the trigger condition specifies “outside,” and if the current location of the terminal is inside the geographic area when the trigger condition specifies “inside.”

41. A computer program product according to claim 36, wherein the first executable portion is adapted to send a request further including an action such that it can be determined whether to execute the action based upon a comparison of a current location of the terminal and the geographic area defined in the predetermined manner.

42. A computer program product according to claim 41, wherein the first executable portion is adapted to send a request further including a validity time and a trigger condition such that it can be determined whether to provide the requested differential location service by:
determining if the subscription is valid based upon a current time and the validity time; and if the subscription is valid,
obtaining a current location of the terminal, and thereafter transforming the current location of the terminal to thereby define the current location in the predetermined manner;
comparing the current location of the terminal defined in the predetermined manner with the geographic area defined in the predetermined manner; and
executing the action if, based upon the comparison, the current location of the terminal satisfies the trigger condition.
